(19) United States
(12) Patent Application Publication
(10) Pub. No.: US 2026/0222274 A1
(43) Pub. Date: Jul. 30, 2026

(54) SYSTEMS AND METHODS FOR DYNAMIC DATA TRANSMISSION PATH MODIFICATION IN A DISTRIBUTED NETWORK

(71) Applicant: BANK OF AMERICA CORPORATION, Charlotte, NC (US)

(72) Inventors: Shravan Kumar Vellore Suresh, Bothell, WA (US); Manoj Shankar, Bothell, WA (US)

(73) Assignee: BANK OF AMERICA CORPORATION, Charlotte, NC (US)

(21) Appl. No.: 19/038,042

(22) Filed: Jan. 27, 2025

(51) Int. Cl. H04L 41/0631; H04L 41/0681; H04L 41/16

(52) U.S. Cl. CPC H04L 41/0631; H04L 41/0681; H04L 41/16

(57) ABSTRACT

Systems, methods, and computer program products are provided herein for dynamic data transmission path modification in a distributed network. An example method includes accessing a first data transmission path where the first data transmission path is associated with an intended interaction of a first user and determining a failure condition associated with the intended interaction of the first user. The example method also includes generating a plurality of candidate data transmission paths associated with the first user and the intended interaction and determining a second data transmission path for effectuating the intended interaction of the first user from amongst the plurality of candidate data transmission paths. The example method further includes establishing communication for the intended interaction of the first user via the second data transmission path.

### TECHNOLOGICAL FIELD

Example embodiments of the present disclosure relate generally to distributed networks and, more particularly, to systems and methods for dynamic data transmission path modification in these network implementations.

### BACKGROUND

Electronic networks formed of distributed components may host, permission access to, or otherwise support interactions with a variety of applications in order to perform the various operations associated with the network. An interaction by a user in such a network may also, for example, include various data transmission paths for effectuating a particular interaction. Applicant has identified a number of deficiencies and problems associated with conventional systems and associated methods. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided herein for dynamic data transmission path modification in a distributed network. In one embodiment, a system for dynamic data transmission path modification in a distributed network is provided. The system may have at least one non-transitory storage device and at least one processor coupled to the at least one non-transitory storage device. The at least one processor may be configured to access a first data transmission path where the first data transmission path is associated with an intended interaction of a first user and determine a failure condition associated with the intended interaction of the first user. The at least one processor may be further configured to generate a plurality of candidate data transmission paths associated with the first user and the intended interaction and determine a second data transmission path for effectuating the intended interaction of the first user from amongst the plurality of candidate data transmission paths.

The at least one processor may be further configured to establish communication for the intended interaction of the first user via the second data transmission path.

In some embodiments, the at least one processor may be further configured to deploy a script on the first transmission path during access of the first data transmission path by the first user and generate metadata associated with the intended interaction of the first user on the first data transmission path responsive to one or more user actions.

In some further embodiments, the at least one processor may be further configured to determine the failure condition associated with the intended interaction of the first user based on the generated metadata.

In some embodiments, the at least one processor may be further configured to determine one or more user actions that fail to effectuate the intended interaction via the first data transmission path and determine the failure condition associated with the intended interaction based on the one or more user actions.

In some further embodiments, the at least one processor may be further configured to compare a count of user actions that fail to effectuate the intended interaction via the first data transmission path with a failure threshold and determine the failure condition in an instance in with the count satisfies the failure threshold.

In some still further embodiments, the failure threshold may be variable based on a type associated with the intended interaction.

In some embodiments, the at least one processor may be further configured to identify the plurality of candidate data transmission paths, generate a score for each of the candidate data transmission paths that is indicative of a viability of the respective candidate data transmission path with respect to the intended interaction, and determine the second data transmission path based on the generated scores.

In some further embodiments, the at least one processor may be further configured to deploy a trained machine learning (ML) model on the plurality of candidate data transmission paths to determine the second data transmission path.

In some embodiments, the at least one processor may be further configured to determine an absence of a viable second data transmission path and generate one or more data structures associated with the first user and the failure condition of the intended interaction.

In another embodiment, a computer program product for dynamic data transmission path modification in a distributed network is provided. The computer program product may include a non-transitory computer-readable medium including code that, when executed, causes an apparatus to: access a first data transmission path, wherein the first data transmission path is associated with an intended interaction of a first user; determine a failure condition associated with the intended interaction of the first user; generate a plurality of candidate data transmission paths associated with the first user and the intended interaction; determine a second data transmission path for effectuating the intended interaction of the first user from amongst the plurality of candidate data transmission paths; and establish communication for the intended interaction of the first user via the second data transmission path.

In another embodiment, a method for dynamic data transmission path modification in a distributed network is provided. The method may include accessing a first data transmission path, wherein the first data transmission path is associated with an intended interaction of a first user; determining a failure condition associated with the intended interaction of the first user; generating a plurality of candidate data transmission paths associated with the first user and the intended interaction; determining a second data transmission path for effectuating the intended interaction of the first user from amongst the plurality of candidate data transmission paths; and establishing communication for the intended interaction of the first user via the second data transmission path.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below. The features, functions, and advantages that are described herein may be achieved independently in various embodiments of the present disclosure or may be combined with yet other embodiments.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for dynamic data transmission path modification in a distributed network in accordance with one or more embodiments of the present disclosure;

FIG. 2 illustrates an example method for dynamic data transmission path modification in accordance with one or more embodiments of the present disclosure;

FIG. 3 illustrates an example method for failure condition determinations in accordance with one or more embodiments of the present disclosure; and

FIG. 4 illustrates an example method for candidate data transmission path evaluation in accordance with one or more embodiments of the present disclosure.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with or who otherwise interacts with an entity. As such, in some embodiments, the user may be an individual having past relationships, current relationships, and/or potential future relationships with an entity. In some embodiments, the user may be an employee (e.g., an associate, a project manager, an IT specialist, a manager, an administrator, an internal operations analyst, or the like) of the entity or enterprises affiliated with the entity. In some embodiments, the user may be a customer (e.g., individual, business, etc.) that transacts with the entity or enterprises associated with the entity. In some embodiments, the “user(s)” described herein may refer to a user, system, device, etc. associated with a third party service provider.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users. The present disclosure contemplates that the arrangement, presentation, organization, etc. of the user interfaces described herein may vary based upon the intended application of the system.

As used herein, an “engine” or “module” may refer to core elements of an application, or part of an application that serves as a foundation for a larger piece of software and drives the functionality of the software. In some embodiments, an engine or module may be self-contained, but externally-controllable code that encapsulates powerful logic designed to perform or execute a specific type of function. In one aspect, an engine or module may be underlying source code that establishes file hierarchy, input and output methods, and how a specific part of an application interacts or communicates with other software and/or hardware. The specific components of an engine or module may vary based on the needs of the specific application as part of the larger piece of software. In some embodiments, an engine or module may be configured to retrieve resources created in other applications, which may then be ported into the engine for use during specific operational aspects of the engine. An engine or module may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” “communicably coupled” and/or the like as used herein, means that the components may be formed integrally with each other, or may be formed separately and coupled together. Furthermore, the components may be formed directly to each other, or to each other with one or more components located between the components that are operatively coupled together. Furthermore, the components may be detachable from each other, or they may permanently coupled together. Furthermore, operatively coupled components may mean that the components retain at least some freedom of movement in one or more directions or may be rotated about an axis (e.g., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer or transmission of data between devices, a system and an application, an accessing of stored data by one or more nodes of a computing cluster, a transmission of a requested task, or the like. As described hereinafter, an “interaction” between the system and one or more applications may be permissioned in that the ability for the system (e.g., one or more devices, subsystems, modules, etc.) to access a particular application may be controlled by permissions issued by this application. In some embodiments as described herein, an interaction may refer to one or more actions by a user via a data transmission path. By way of a non-limiting example, an interaction as described herein may refer to one or more actions by a first user to complete an authentication process for accessing a particular application.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a criterion, including that a threshold has been met, passed, exceeded, etc.

As described above, electronic networks formed of distributed components may host, permission access to, or otherwise support interactions with a variety of applications in order to perform the various operations associated with the network. One or more users may interact with the network (e.g., applications, devices, systems, etc. of the network) by leveraging various data transmission paths that establish communication, access, or the like between an example user and the intended component or application of the network. An interaction by a user in such a network may also, for example, include a plurality of candidate data transmission paths (e.g., options) for effectuating a particular interaction. By way of a non-limiting example, an interaction as described herein may refer to one or more actions by a first user to complete an authentication process for accessing a particular application. In some instances, however, the primary transmission path by which the user intends to effectuate the interaction may fail or otherwise be unavailable to the user.

In order to solve these issues and others, embodiments of the present disclosure provide systems and methods for dynamic data transmission path modification in a distributed network. For example, the embodiments described herein may access a first data transmission path that is associated with an intended interaction of a first user and determine a failure condition associated with the intended interaction of the first user, such as via deploying a script during attempted access of the first data transmission path and generating metadata associated with the interaction. Thereafter, the systems described herein may generate a plurality of candidate data transmission paths associated with the first user and the intended interaction, determine a second data transmission path for effectuating the intended interaction of the first user from amongst the plurality of candidate data transmission paths, and establish communication for the intended interaction of the first user via the second data transmission path. In some embodiments, the system may further leverage machine learning (ML) model and artificial intelligence (AI) techniques to determine viable data transmission paths and/or select a data transmission path for a particular interaction and user. In doing so, the embodiments of the present disclosure provide new mechanisms for determining failure conditions for user interactions and determining viable alternative transmission paths for effectuating the same that were historically unavailable.

### Example System and Circuitry Components

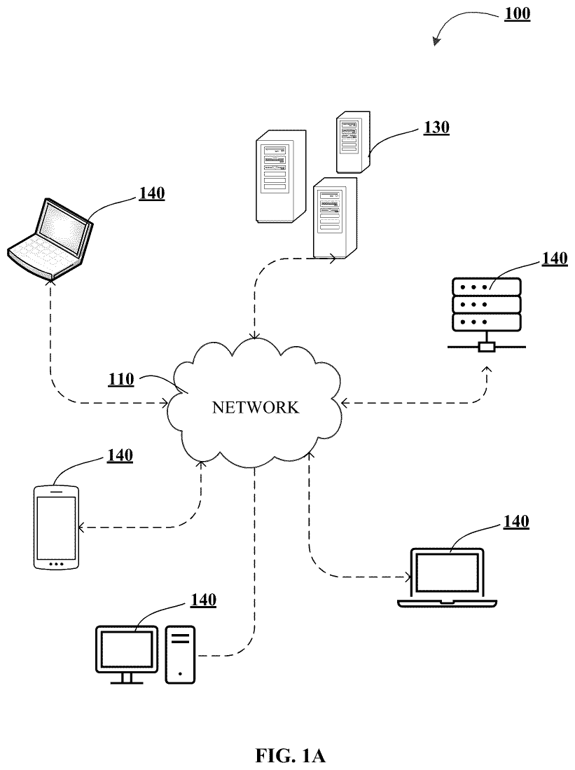

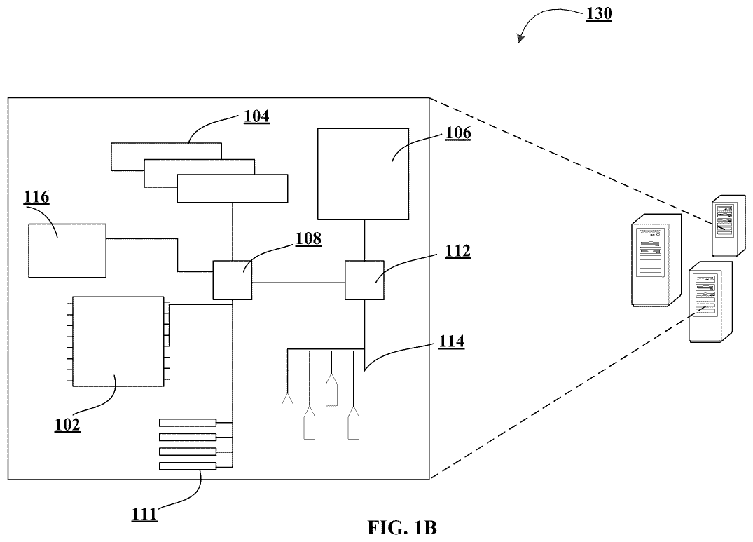

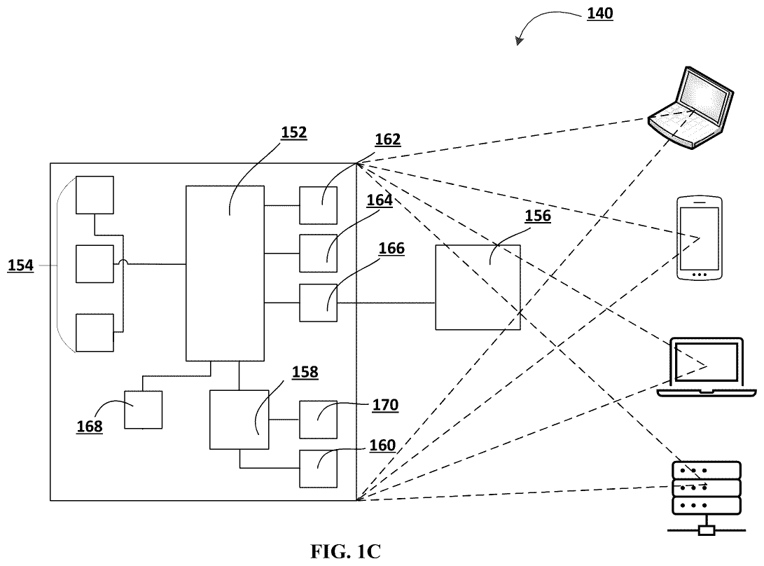

FIGS. 1A-1C illustrate technical components of an exemplary distributed computing environment for dynamic data transmission path modification 100, in accordance with one or more embodiments of the present disclosure. As shown in FIG. 1A, the distributed computing environment 100 or distributed network 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, the same or similar to system 130, with each system providing portions of the necessary operations (e.g., as a server bank, a group of blade servers, or a multi-processor system).

In some embodiments, the system 130 and the end-point device(s) 140 may define a client-server relationship in which the end-point device(s) 140 are remote devices that request and receive service from a centralized server (e.g., the system 130). In some other embodiments, the system 130 and the end-point device(s) 140 may have a peer-to-peer relationship in which the system 130 and the end-point device(s) 140 have the same abilities to use the resources available on the network 110. As opposed to relying upon a central server (e.g., system 130) that acts as the shared drive, each device that is connected to the network 110 acts as the server for the files stored thereon.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 (e.g., data entities) may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., an automated teller machine (ATM)), and/or edge devices such as routers, routing switches, integrated access devices (IAD), and/or the like. As described hereinafter, in some embodiments, the end-point devices 140 may be data entities that are linked with the subject data application described herein.

The network 110 may be a distributed network that is spread over different networks. This provides a single data communication network that may be managed jointly or separately by each network. In addition to shared communication within the network, the distributed network may also support distributed processing. The network 110 may be a form of digital communication network, such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the embodiments of the present disclosure. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with one or more embodiments of the present disclosure. As shown in FIG. 1B, the system 130 may include a processor 102, memory 104, input/output (I/O) device 116, and/or a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 may process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 may be capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and/or to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other. As described herein, in some embodiments, the system 130 may operate as the centralized server configured to perform the data transmission path modification operations described herein.

FIG. 1C illustrates an exemplary component-level structure of the end-point device(s) 140 (e.g., data entities described herein), in accordance with one or more embodiments of the present disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a Microdrive or other device, to provide additional storage. Each of the components 152, 154, 158, and 160, are interconnected using various buses, and several of the components may be mounted on a common motherboard or in other manners as appropriate. As described above, the end-point devices 140 described herein may be example data entities that form the distributed network. As such, the system 130 may be communicably coupled with the end-point devices 140 so as to receive data transmissions from these devices that may, for example, be used for data transmission path modification.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user (e.g., an actionable notification or the like). The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 (e.g., data entities) to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 (e.g., data entities) may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 (e.g., data entities) may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.Various implementations of the distributed computing environment 100, including the system 130 and end-point device(s) 140 (e.g., data entities), and techniques described here may be realized in digital electronic circuitry, integrated circuitry, specially designed ASICs (application specific integrated circuits), computer hardware, firmware, software, and/or combinations thereof.

### Example Methods for Dynamic Data Transmission Path Modification

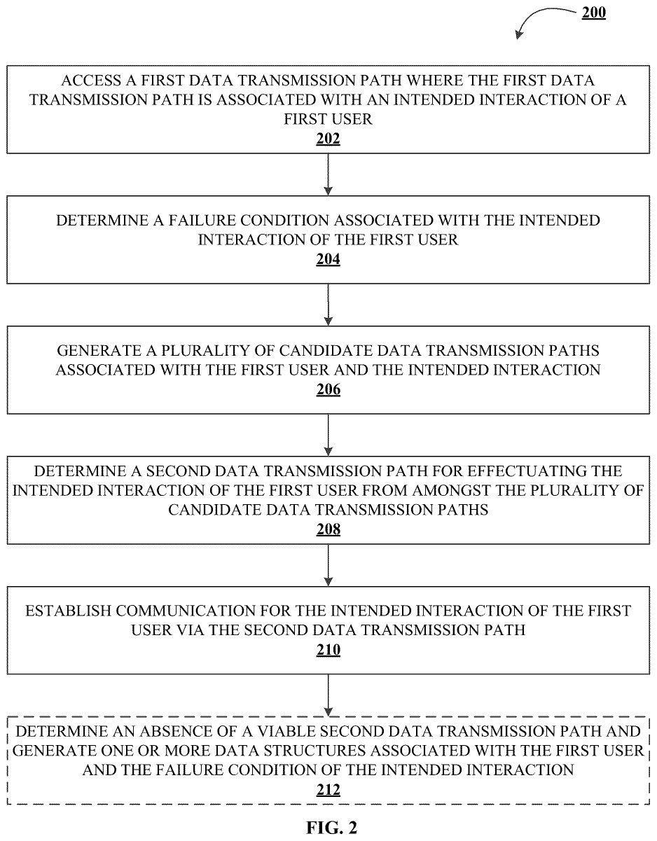

FIG. 2 illustrates a flowchart containing a series of operations for dynamic data transmission path modification in a distributed network (e.g., method 200). The operations illustrated in FIG. 2 may, for example, be performed by, with the assistance of, and/or under the control of an apparatus (e.g., system 130, end-point devices 140 (e.g., data entities), etc.), as described above. In this regard, performance of the operations may invoke one or more of the components described above with reference to FIGS. 1A-1C (e.g., processor 102, processor 152, etc.).

As shown in operation 202, the system 130 may be configured to access a first data transmission path that is associated with an intended interaction of a first user. As described above, the system 130 may operate as a centralized server that is configured to perform the data transmission path modification operations described herein. For example, the system 130 may host, permission access to, or otherwise support interactions with a variety of applications associated with the system 130. By way of a non-limiting example, an interaction as described herein may refer to one or more actions by a first user to complete an authentication process for accessing a particular application. Although described hereinafter with reference to an example authentication based interaction, the present disclosure contemplates that an interaction as described herein may refer to any action, access, application, etc. associated with the system 130 without limitation. Furthermore, the present disclosure contemplates that an intended interaction may include any number of related, dependent, or otherwise implicated interactions associated with the intended interaction. For example, an intended interaction of authentication as described herein may include various sub-interactions (e.g., two factor authentication, one-time password (OTP) generation, continuous authentication, biometric evaluation, image processing, etc.) that may collectively be referred to as the “intended interaction.”

An example data transmission path may refer to any mechanism by which the first user attempts to effectuate the intended interaction without limitation. In some embodiments, the data transmission path may refer to a communication channel by which data is transmitted between the user (e.g., a device associated with the user) and the system 130. For example, the first data transmission path may refer to an attempt to access an application (e.g., the intended application) via a mobile application, website, voice call, and/or the like. Additionally or alternatively, in some embodiments, the first data transmission path may refer to a particular mechanism for effectuating the intended interaction via the same communication channel. By way of continued example, the first user may attempt to be authenticated via access credentials over a web-based application, such that the access credentials on the web-based application may be considered the first data transmission path. As described more fully hereinafter with reference to the determination of a viable second data transmission path, the present disclosure contemplates that any number of data transmission paths (e.g., mechanisms for effectuating the intended interaction) may be used by the system 130.

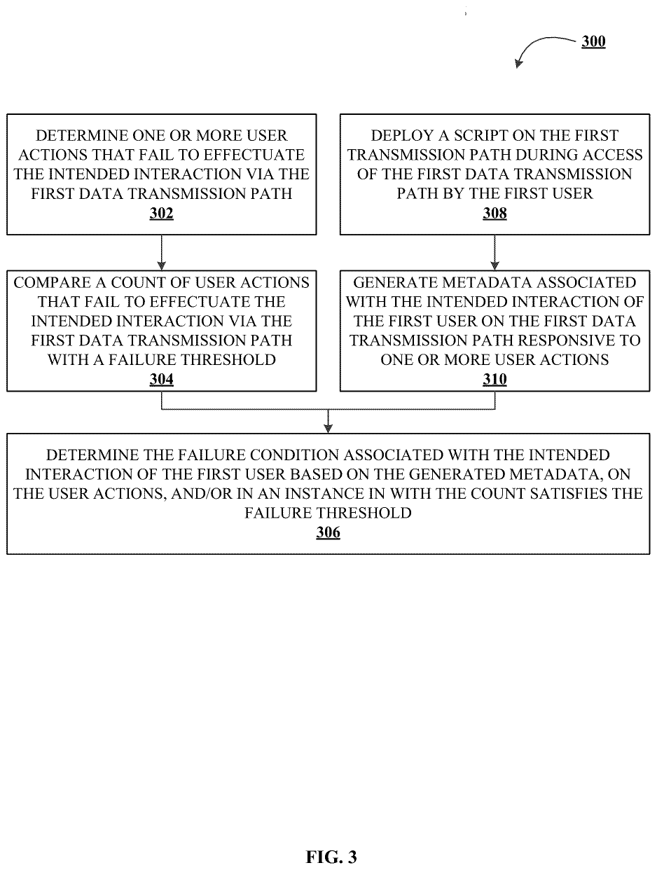

Thereafter, as shown in operation 204, the system 130 may be configured to determine a failure condition associated with the intended interaction of the first user. As described more fully hereinafter with reference to the operations of FIG. 3, the system 130 may leverage various scripts that are deployed on the first data transmission path in order to determine that a failure condition is present with respect to the intended interaction of the first user. As described herein, a failure condition may refer to any state in which the first user is unable to effectuate the intended interaction. By way of continued example, in an instance in which the intended interaction refers to an authentication of the first user in order to access an application associated with the system 130, any failure to authenticate the first user may result in a failure condition. In some embodiments, the failure condition may be the result of an action or inaction by the user (e.g., a failure to update access credentials or the like). Additionally or alternatively, in some embodiments, the failure condition may be the result of component or application failure by the system 130. The present disclosure contemplates that the failure condition may be associated with or indicative of any instance in which the first user is unable to effectuate the intended interaction via the first data transmission path.

As described with reference to FIG. 3, in some embodiments, the system may deploy a script on the first transmission path during access of the first data transmission path by the first user and generate metadata associated with the intended interaction of the first user on the first data transmission path responsive to one or more user actions. By way of continued example, the first user may attempt to provide account credential for authentication purposes, and the deployed script may generate metadata that is indicative of the result of these authentication process (e.g., the intended interaction). By way of an additional example, the metadata generated by the deployed script may be indicative of a number and/or proximity between attempted actions (e.g., user inputs, clicks, etc.) on a web-based application (e.g., the first data transmission path) by the first user. The present disclosure contemplates that the metadata generated by the deployed script may be indicative of any action or inaction by the first user with respect to the intended interaction on the first data transmission path.

Thereafter, as shown in operation 206, the system 130 may be configured to generate a plurality of candidate data transmission paths associated with the first user and the intended interaction. As described above, the system 130 may be associated with any number of data transmission paths (e.g., mechanisms for effectuating the intended interaction) that may be used to effectuate the intended interaction. In some embodiments, the plurality of candidate data transmission paths may be determined based on the nature of the system 130 and/or the intended interaction. For example, the system 130 may be configured (e.g., via hardware limitations, applications limitations, etc.) to employ a defined number of data transmission paths for a particular intended interaction. By way of continued example, the system 130 may be configured to employ a defined number of mechanisms (e.g., data transmission paths) for authenticating a particular user. In other embodiments, the plurality of candidate data transmission paths may be determined based on the associated user (e.g., the first user). By way of continued example, the first user may have a defined number of data transmission paths (e.g., via hardware limitations or the like) by which the first user may be authenticated (e.g. multiple user devices, multiple account credentials, etc.). The present disclosure contemplates that any number of candidate data transmission paths may be generated by the system 130 based on the first user, the natures of the intended interaction, and/or the like without limitation.

Thereafter, as shown in operations 208 and 210, the system 130 may be configured to determine a second data transmission path for effectuating the intended interaction of the first user from amongst the plurality of candidate data transmission paths and establish communication for the intended interaction of the first user via the second data transmission path. By way of continued example, the intended interaction of the first user may be associated with an authentication operation for the first user. In such an example, the failure condition described above with reference to operation 204 may refer to a failure of the system 130 to authenticate the first user via the first data transmission path (e.g., the web-based application). In such an example embodiment, the system may identify a second data transmission oath (e.g., a mobile device based action) that may be used to authenticate the first user. In such an embodiment, at operation 210, the system 130 may establish communication for the intended interaction via the second data transmission path. By way of continued example, the system 130 may authenticate the first user via the mobile device based action as opposed to the web-based application (e.g., the first data transmission path having a failure condition).

In some embodiments, as shown in operation 212, the system 130 may determine an absence of a viable second data transmission path and generate one or more data structures associated with the first user and the failure condition of the intended interaction. By way of example, in some embodiments, a viable second data transmission path may not exist for the first user and/or the intended interaction. In some instances, for example, the first user may not possess or have access to an alternative mechanism for authentication and/or the system 130 may similarly fail to provide an alternative mechanism for authentication (e.g., a system failure). In such an embodiment, the system 130 may operate to generate a data record, log, or other data structure that contains or is otherwise associated with the failure condition of the intended interaction. These data structure(s) may be provided, for example, to a service provider, system maintenance service, user system, and/or the like to facilitate remediation of the failure condition.

FIG. 3 illustrates a flowchart containing a series of operations for failure condition determinations (e.g., method 300). The operations illustrated in FIG. 3 may, for example, be performed by, with the assistance of, and/or under the control of an apparatus (e.g., system 130, end-point devices 140 (e.g., data entities), etc.), as described above. In this regard, performance of the operations may invoke one or more of the components described above with reference to FIGS. 1A-1C (e.g., processor 102, processor 152, etc.).

As shown in operations 302 and 304, the system 130 may be configured to determine one or more user actions that fail to effectuate the intended interaction via the first data transmission path and determine the failure condition associated with the intended interaction based on the one or more user actions. In particular, in some embodiments, the system 130 compare a count of user actions that fail to effectuate the intended interaction via the first data transmission path with a failure threshold. By way of continued example, the system 130 may, via a deployed script or otherwise, monitor the actions of the first user via the first data transmission path as related to the intended interaction. In some embodiments, for example, the first user may attempt to provide access credentials for authenticating access to an application associated with the system (e.g., the intended interaction). By way of a particular, non-limiting example, the metadata generated by the deployed script may be indicative of a number and/or proximity between attempted actions (e.g., user inputs, clicks, etc.) on a web-based application (e.g., the first data transmission path) by the first user that may be indicative of a failure condition. In such an example, the system 130 may determine the failure condition, as described at operation 306 in an instance in with the count satisfies the failure threshold (e.g. the number of user clicks, failed log in attempts, etc. exceeds the threshold). In some embodiments, the failure threshold is variable based on a type associated with the intended interaction. For example, the system 130 may be aware of a system outage such that the threshold for seeking an alternative data transmission path is reduced.

Additionally or alternatively, as shown in operations 308 and 310, the system 130 may be configured to deploy a script on the first transmission path during access of the first data transmission path by the first user and generate metadata associated with the intended interaction of the first user on the first data transmission path responsive to one or more user actions. As described above, the system 130 may, during the first user's interaction via the first data transmission path, deploy a script, such as on the example web-based application, to monitor the actions of the first user. In such an embodiment, the system may determine the failure condition based on the generated metadata as described at operation 306. The present disclosure contemplates that the system 130 may leverage any technique, mechanism, etc. for identifying the actions of the first user with respect to the first data transmission path and the intended interaction. The present disclosure further contemplates that the operations described herein may be iteratively performed during the modification of the data transmission path so as to iteratively improve the failure condition determinations described herein. As shown in operation 306, the system 130 may be configured to determine the failure condition associated with the intended interaction of the first user based on the generated metadata, on the user actions, and/or in an instance in with the count satisfies the failure threshold as described herein.

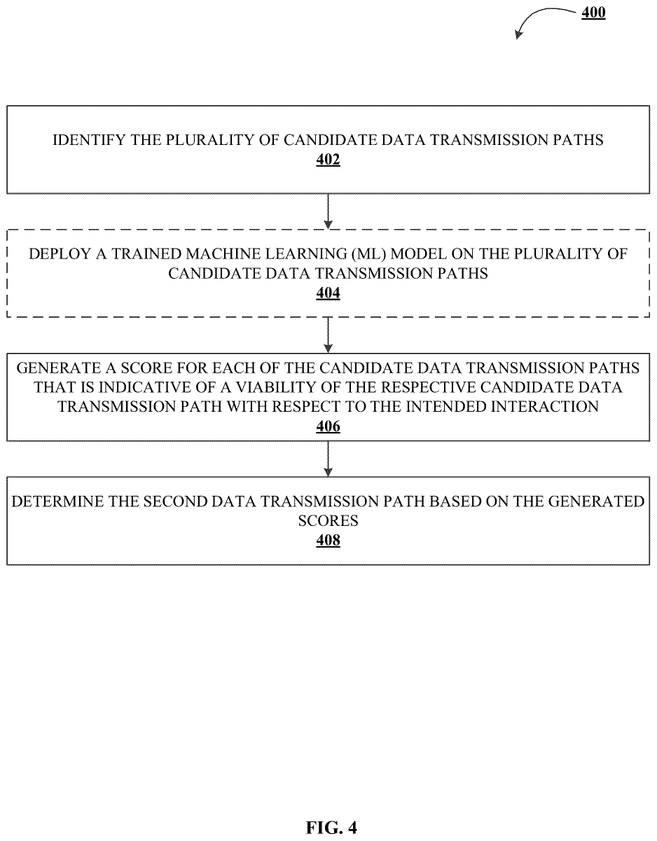

FIG. 4 illustrates a flowchart containing a series of operations for candidate data transmission path evaluation (e.g., method 400). The operations illustrated in FIG. 4 may, for example, be performed by, with the assistance of, and/or under the control of an apparatus (e.g., system 130, end-point devices 140 (e.g., server devices), etc.), as described above. In this regard, performance of the operations may invoke one or more of the components described above with reference to FIGS. 1A-1C (e.g., processor 102, processor 152, etc.).

As shown in operation 402, the system 130 may be configured to identify the plurality of candidate data transmission paths. In some embodiments, the set of candidate data transmission paths may be defined by the system 130 and/or the intended interaction. By way of continued example, the authentication of the first user (e.g., the intended interaction) may require various applications, hardware components, etc. of the system 130 such that there are defined number of possible (e.g., viable) mechanisms (e.g., data transmission paths) that may properly effectuate authentication. As such, in some embodiments, the identification of the plurality of candidate data transmission paths may include a determination, query, etc. of the mechanisms available to the system 130. Similarly, in some embodiments, the set of candidate data transmission paths may be defined by the first user. By way of continued example, the authentication of the first user (e.g., the intended interaction) may require various applications, hardware components, etc. of the first user such that there are defined number of possible (e.g., viable) mechanisms (e.g., data transmission paths) that may properly effectuate authentication. As such, in some embodiments, the identification of the plurality of candidate data transmission paths may include a determination, query, etc. of the mechanisms available to the first user.

In some embodiments, as shown in operation 404, the system 130 may be configured to deploy a trained machine learning (ML) model on the plurality of candidate data transmission paths to determine the second data transmission path described herein. The trained ML model may also refer to a mathematical model generated by machine learning algorithms based on training data (e.g., various feature sets of access permissions), to make predictions or decisions without being explicitly programmed to do so. The trained ML model may similarly represent what was learned by the selected machine learning algorithm and represent the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. The trained ML model or algorithm may also refer to programs that are configured to self-adjust and perform better as they are exposed to more data. To this extent, the trained ML model or algorithm is also capable of adjusting its own parameters, based on previous performance in making prediction about a dataset.

The ML algorithms contemplated, described, and/or used herein (e.g., the trained ML model) may include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

The ML models may be trained using repeated execution cycles of experimentation, testing, and tuning to modify the performance of the ML algorithm and refine the results in preparation for deployment of those results for consumption or decision making. The ML models may be tuned by dynamically varying hyperparameters in each iteration (e.g., number of trees in a tree-based algorithm or the value of alpha in a linear algorithm), running the algorithm on the data again, and then comparing its performance on a validation set to determine which set of hyperparameters results in the most accurate model. The accuracy of the model is the measurement used to determine which set of hyperparameters is best at identifying relationships and patterns between variables in a dataset based on the input, or training data. A fully trained ML model is one whose hyperparameters are tuned and model accuracy maximized.

Thereafter, as shown in operation 406, the system 130 may be configured to generate a score for each of the candidate data transmission paths that is indicative of a viability of the respective candidate data transmission path with respect to the intended interaction. By way of example, the system 130 may, via the ML models or otherwise, assign a value, score, or other indicator to each of the plurality of candidate data transmission paths that represents the likelihood of successfully effectuating the intended interaction. In some embodiments, these scores may be based, at least in part, on the prior interaction of the first user and/or other users. For example, the system 130 may weight a particular data transmission path relatively higher (e.g., a larger score) due to prior successful interactions similar to the intended interaction of the first user. The present disclosure contemplates that the score for each candidate data transmission path may also be dynamically varied in response to updated data generated by the system 130 and that the system 130 may leverage any number of varying data sources to iteratively improve the second data transmission path selection. As shown in operation 408, for example, the system may be configured to determine the second data transmission path based on the generated scores (e.g., selecting the highest score or the like). The present disclosure contemplates that the viability of a particular data transmission path may be interaction specific or dependent and/or may be user specific or dependent. Said differently, the system 130 may determine different data transmission paths for different users and/or different intended interactions. The operations of FIG. 4 may be iteratively completed in order to iteratively improve the determination of the second data transmission path.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that may direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments may be configured without departing from the scope and spirit of the disclosure. Therefore, it is to be understood that, within the scope of the appended claims, the disclosure may be practiced other than as specifically described herein.

What is claimed is:

1. A system for dynamic data transmission path modification in a distributed network, the system comprising:
at least one non-transitory storage device; and
at least one processor coupled to the at least one non-transitory storage device, wherein the at least one processor is configured to:
access a first data transmission path, wherein the first data transmission path is associated with an intended interaction of a first user;
determine a failure condition associated with the intended interaction of the first user;
generate a plurality of candidate data transmission paths associated with the first user and the intended interaction;
determine a second data transmission path for effectuating the intended interaction of the first user from amongst the plurality of candidate data transmission paths; and
establish communication for the intended interaction of the first user via the second data transmission path.

2. The system of claim 1, wherein the at least one processor is further configured to:
deploy a script on the first transmission path during access of the first data transmission path by the first user; and
generate metadata associated with the intended interaction of the first user on the first data transmission path responsive to one or more user actions.

3. The system of claim 2, wherein the at least one processor is further configured to determine the failure condition associated with the intended interaction of the first user based on the generated metadata.

4. The system of claim 1, wherein the at least one processor is further configured to:
determine one or more user actions that fail to effectuate the intended interaction via the first data transmission path; and
determine the failure condition associated with the intended interaction based on the one or more user actions.

5. The system of claim 4, wherein the at least one processor is further configured to:
compare a count of user actions that fail to effectuate the intended interaction via the first data transmission path with a failure threshold; and
determine the failure condition in an instance in with the count satisfies the failure threshold.

6. The system of claim 5, wherein the failure threshold is variable based on a type associated with the intended interaction.

7. The system of claim 1, wherein the at least one processor is further configured to:
identify the plurality of candidate data transmission paths;
generate a score for each of the candidate data transmission paths that is indicative of a viability of the respective candidate data transmission path with respect to the intended interaction; and
determine the second data transmission path based on the generated scores.

8. The system of claim 7, wherein the at least one processor is further configured to deploy a trained machine learning (ML) model on the plurality of candidate data transmission paths to determine the second data transmission path.

9. The system of claim 1, wherein the at least one processor is further configured to:
determine an absence of a viable second data transmission path; and
generate one or more data structures associated with the first user and the failure condition of the intended interaction.

10. A computer program product for dynamic data transmission path modification in a distributed network, the computer program product comprising a non-transitory computer-readable medium comprising code that, when executed, causes an apparatus to:
access a first data transmission path, wherein the first data transmission path is associated with an intended interaction of a first user;
determine a failure condition associated with the intended interaction of the first user;
generate a plurality of candidate data transmission paths associated with the first user and the intended interaction;
determine a second data transmission path for effectuating the intended interaction of the first user from amongst the plurality of candidate data transmission paths; and
establish communication for the intended interaction of the first user via the second data transmission path.

11. The computer program product of claim 10, further comprising code that, when executed, causes the apparatus to:
deploy a script on the first transmission path during access of the first data transmission path by the first user;
generate metadata associated with the intended interaction of the first user on the first data transmission path responsive to one or more user actions; and
determine the failure condition associated with the intended interaction of the first user based on the generated metadata.

12. The computer program product of claim 10, further comprising code that, when executed, causes the apparatus to:
determine one or more user actions that fail to effectuate the intended interaction via the first data transmission path; and
determine the failure condition associated with the intended interaction based on the one or more user actions.

13. The computer program product of claim 12, further comprising code that, when executed, causes the apparatus to:
compare a count of user actions that fail to effectuate the intended interaction via the first data transmission path with a failure threshold; and
determine the failure condition in an instance in with the count satisfies the failure threshold.

14. The computer program product of claim 10, further comprising code that, when executed, causes the apparatus to:
identify the plurality of candidate data transmission paths;
generate a score for each of the candidate data transmission paths that is indicative of a viability of the respective candidate data transmission path with respect to the intended interaction; and
determine the second data transmission path based on the generated scores.

15. The computer program product of claim 14, further comprising code that, when executed, causes the apparatus to deploy a trained machine learning (ML) model on the plurality of candidate data transmission paths to determine the second data transmission path.

16. A method for dynamic data transmission path modification in a distributed network, the method comprising:
accessing a first data transmission path, wherein the first data transmission path is associated with an intended interaction of a first user;
determining a failure condition associated with the intended interaction of the first user;
generating a plurality of candidate data transmission paths associated with the first user and the intended interaction;
determining a second data transmission path for effectuating the intended interaction of the first user from amongst the plurality of candidate data transmission paths; and
establishing communication for the intended interaction of the first user via the second data transmission path.

17. The method of claim 16, further comprising:
deploying a script on the first transmission path during access of the first data transmission path by the first user;
generating metadata associated with the intended interaction of the first user on the first data transmission path responsive to one or more user actions; and
determining the failure condition associated with the intended interaction of the first user based on the generated metadata.

18. The method of claim 16, further comprising:
determining one or more user actions that fail to effectuate the intended interaction via the first data transmission path; and
determining the failure condition associated with the intended interaction based on the one or more user actions.

19. The method of claim 18, further comprising:
comparing a count of user actions that fail to effectuate the intended interaction via the first data transmission path with a failure threshold; and
determining the failure condition in an instance in with the count satisfies the failure threshold.

20. The method of claim 16, further comprising:
identifying the plurality of candidate data transmission paths;
generating a score for each of the candidate data transmission paths that is indicative of a viability of the respective candidate data transmission path with respect to the intended interaction; and
determining the second data transmission path based on the generated scores.
